(19) United States
(12) Patent Application Publication
(10) Pub. No.: US 2025/0199830 A1
(43) Pub. Date: Jun. 19, 2025

(54) INFORMATION DISPLAY METHOD, MEDIUM AND ELECTRONIC DEVICE

(71) Applicant: DOUYIN VISION CO., LTD., Beijing (CN)

(72) Inventors: Qing LIU, Beijing (CN); Shuisheng ZHANG, Beijing (CN); Danchi FAN, Beijing (CN); Yuan ZHANG, Beijing (CN)

(21) Appl. No.: 18/980,551

(22) Filed: Dec. 13, 2024

(30) Foreign Application Priority Data
Dec. 15, 2023 (CN) 202311735923.7

(51) Int. Cl. G06F 9/451; G06F 3/0482; G06F 3/16

(52) U.S. Cl. CPC G06F 9/453; G06F 3/0482; G06F 3/167

(57) ABSTRACT

An information display method, a medium and an electronic device are provided. The method includes: displaying a first interface, in which the first interface includes a question input control and a first intention control; displaying a questioning text on the first interface in response to an input operation on the question input control; displaying, in response to a selection operation on a plurality of candidate intentions provided by the first intention control, a first target intention corresponding to the selection operation in a display area corresponding to the first intention control; and displaying, in response to a generation operation, response information that corresponds to the questioning text and satisfies the first target intention on the first interface.

### CROSS-REFERENCE TO RELATED APPLICATION

The present application claims priority of the Chinese Patent Application No. 202311735923.7, filed on Dec. 15, 2023, the disclosure of which is incorporated herein by reference in its entirety as part of the present application.

### TECHNICAL FIELD

The present disclosure relates to an information display method, a medium and an electronic device.

### BACKGROUND

In scenarios of data search and analysis, a user usually interacts with a data system in a dialog manner to obtain a desired data result from the data system.

In some cases, a fixed answer can be obtained only for the same question, which cannot flexibly adapt to different intentions of the user. When the user wants to obtain a data result that satisfies the user's intention, the user needs to change the questioning text for many times, resulting in low data acquisition efficiency and poor user experience.

### SUMMARY

The summary is provided to introduce a selection of concepts in a simplified form that are further described below in the detailed description. The summary is not intended to identify key features or essential features of the claimed subject matter, nor is it intended to be used to limit the scope of the claimed subject matter.

The present disclosure provides an information display method, which includes: displaying a first interface, in which the first interface includes a question input control and a first intention control; displaying a questioning text on the first interface in response to an input operation on the question input control; displaying, in response to a selection operation on a plurality of candidate intentions provided by the first intention control, a first target intention corresponding to the selection operation in a display area corresponding to the first intention control; and displaying, in response to a generation operation, response information that corresponds to the questioning text and satisfies the first target intention on the first interface.

The present disclosure provides an information display apparatus, which includes a first display module, a second display module, a third display module and a fourth display module. The first display module is configured to display a first interface, in which the first interface includes a question input control and a first intention control. The second display module is configured to display a questioning text on the first interface in response to an input operation on the question input control. The third display module is configured to, in response to a selection operation on a plurality of candidate intentions provided by the first intention control, display a first target intention corresponding to the selection operation in a display area corresponding to the first intention control. The fourth display module is configured to display response information that corresponds to the questioning text and satisfies the first target intention on the first interface in response to a generation operation.

The present disclosure provides a non-transitory computer-readable medium, which stores a computer program. When the program is executed by a processor, the processor implements steps of the above information display method.

The present disclosure provides an electronic device, which includes a memory and a processor. The memory is configured to store a computer program; and the processor is configured to execute the computer program in the memory to implement steps of the above information display method.

### BRIEF DESCRIPTION OF DRAWINGS

The above and other features, advantages and aspects of embodiments of the present disclosure become more apparent with reference to the following specific implementations and in conjunction with the accompanying drawings. Throughout the drawings, the same or similar reference numerals denote the same or similar elements. It should be understood that the accompanying drawings are schematic and that parts and elements are not necessarily drawn to scale.

FIG. 1 is a flowchart of an information display method according to an exemplary embodiment of the present disclosure;

FIG. 2 is a schematic diagram of a first interface according to an exemplary embodiment of the present disclosure;

FIG. 3 is another schematic diagram of the first interface according to an exemplary embodiment of the present disclosure;

FIG. 4 is another schematic diagram of the first interface according to an exemplary embodiment of the present disclosure;

FIG. 5 is another schematic diagram of the first interface according to an exemplary embodiment of the present disclosure;

FIG. 6 is another schematic diagram of the first interface according to an exemplary embodiment of the present disclosure;

FIG. 7 is another schematic diagram of the first interface according to an exemplary embodiment of the present disclosure;

FIG. 8 is a block diagram of an information display apparatus according to an exemplary embodiment of the present disclosure; and

FIG. 9 is a structural schematic diagram of an electronic device according to an exemplary embodiment of the present disclosure.

### DETAILED DESCRIPTION

Embodiments of the present disclosure are described in more detail below with reference to the accompanying drawings. Although some embodiments of the present disclosure are shown in the drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and the embodiments of the present disclosure are only for illustrative purposes, and are not intended to limit the scope of protection of the present disclosure.

It should be understood that the various steps described in the method implementations of the present disclosure may be performed in different orders, and/or performed in parallel. Furthermore, additional steps may be included and/or the execution of the illustrated steps may be omitted in the method implementations. The scope of the present disclosure is not limited in this respect.

The terms “include/comprise” used herein and the variations thereof are an open-ended inclusion, namely, “include/comprise but not limited to”. The term “based on” is “at least partially based on”. The term “an embodiment” means “at least one embodiment”. The term “another embodiment” means “at least one another embodiment”. The term “some embodiments” means “at least some embodiments”. Related definitions of the other terms will be given in the description below.

It should be noted that concepts such as “first” and “second” mentioned in the present disclosure are only used to distinguish different apparatuses, modules, or units, and are not used to limit the sequence of functions performed by these apparatuses, modules, or units or the interdependence.

It should be noted that the modifiers “one” and “a plurality of” mentioned in the present disclosure are illustrative and not restrictive, and those skilled in the art should understand that unless the context clearly indicates otherwise, the modifiers should be understood as “one or more”.

Names of messages or information exchanged between a plurality of apparatuses in the implementations of the present disclosure are used for illustrative purposes only, and are not used to limit the scope of these messages or information.

It may be understood that before the technical solutions disclosed in the embodiments of the present disclosure are used, the user should be informed of the types, scope of use, use scenarios, and the like of the personal information involved in the present disclosure in an appropriate manner in accordance with relevant laws, regulations, and rules, and the user's authorization should be obtained.

For example, when receiving an active request from the user, the user is sent prompt information to clearly prompt the user that an operation requested by the user will need to obtain and use the user's personal information. Therefore, the user can independently choose whether to provide personal information to the software or hardware such as an electronic device, an application, a server, or a storage medium that performs the operation of the technical solution of the present disclosure according to the prompt information.

As an optional but non-restrictive implementation, for example, the manner of sending the prompt information to the user in response to receiving the active request from the user may be a pop-up window, and the prompt information may be presented in text in the pop-up window. In addition, the pop-up window may also include a selection control for the user to select “Agree” or “Disagree” to provide personal information to the electronic device.

It may be understood that the above process of notifying and obtaining the user's authorization is only illustrative and does not limit the implementation of the present disclosure. Other manners that satisfy relevant laws, regulations, and rules may also be applied to the implementation of the present disclosure.

In addition, it may be understood that the data involved in the technical solution (including but not limited to data per se, and data acquisition or use) should comply with the requirements of corresponding laws, regulations, and rules.

In some cases, a predefined data search mode is used to implement feedback of data results in data search and analysis scenarios. The predefined data search mode may be understood as generating the answer text corresponding to the questioning text by using a fixed rule and keyword matching. In some scenarios, this method may provide the user with a satisfactory answer text, but it has some obvious defects when facing the user's dynamically changing search requirements. For example, the traditional predefined data search mode cannot adapt to the user's diverse search intentions, resulting in restrictions on the user in obtaining results. If the user needs to obtain a desired data result, the user may need to try different question expressions several times to search for the answer text that conforms to the user's expectation, which directly affects the data acquisition efficiency.

In view of this, embodiments of the present disclosure provide an information display method and apparatus, a medium and an electronic device.

The present disclosure is further explained and described below with reference to the accompanying drawings.

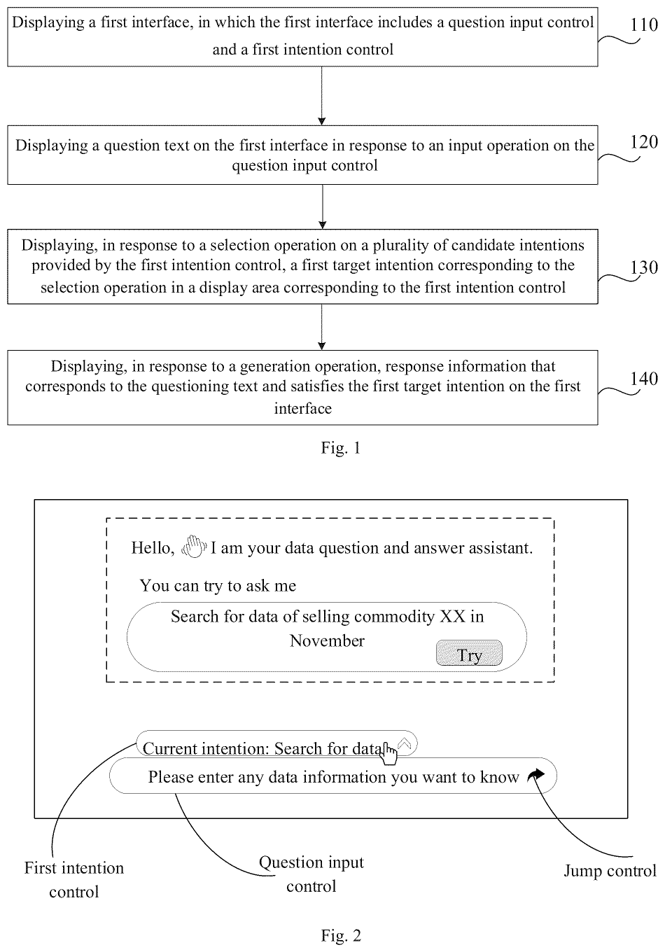

FIG. 1 is a flowchart of an information display method according to an exemplary embodiment of the present disclosure. As shown in FIG. 1, an embodiment of the present disclosure provides an information display method, which may be performed by an electronic device, specifically, may be performed by an information display apparatus. The apparatus may be implemented by means of software and/or hardware, and the software and/or hardware is configured in the electronic device. As shown in FIG. 1, the method may include the following steps.

Step 110: displaying a first interface, in which the first interface includes a question input control and a first intention control.

Step 120: displaying a questioning text on the first interface in response to an input operation on the question input control.

Step 130: displaying, in response to a selection operation on a plurality of candidate intentions provided by the first intention control, a first target intention corresponding to the selection operation in a display area corresponding to the first intention control.

Step 140: displaying, in response to a generation operation, response information that corresponds to the questioning text and satisfies the first target intention on the first interface.

It should be noted that the method shown in Fig. I may be applied to data search and analysis scenarios.

The question input control is used to support the user to input the questioning text, and the first intention control is used to support the user to select an intention.

In data search and analysis scenarios, the user's intention may be to search for data, or may be to consult about the use of data, or to consult about the definition of data, etc. It should be noted that an intention of consulting about the use of data or consulting about the definition of data is hereinafter referred to as business consultation for short.

FIG. 2 is a schematic diagram of a first interface according to an exemplary embodiment of the present disclosure. With reference to FIG. 2, in FIG. 2, the first intention control and the question input control are displayed. For the first intention control, the current intention “Search for data” selected currently is displayed in FIG. 2. Here, the current intention means the first target intention, and the user can click on the first intention control to implement the selection for the current intention. For the question input control, when the user does not perform the input operation on the question input control, a display area corresponding to the question input control may display a prompt word that is used to prompt the user to enter the text. The prompt word is, for example, “Please enter any data information you want to know” in the display area corresponding to the question input control shown in FIG. 2.

When the user performs the input operation on the question input control, the questioning text is displayed in the display area corresponding to the question input control on the first interface. Continuing with the example shown in FIG. 2, the prompt word “Please enter any data information you want to know” may be switched to the questioning text entered by the user.

The plurality of candidate intentions may be configured by operational staff. Continuing with the above example, the plurality of the candidate intentions may include searching for data and business consultation.

The generation operation may be triggered based on a user clicking on a jump control on the first interface. With reference to the example shown in FIG. 2, the display area corresponding to the question input control in FIG. 2 synchronously displays the jump control.

For example, in response to the generation operation, the electronic device displays the questioning text in a question and answer area on the first interface, and displays the corresponding response information below the questioning text. The question and answer area is used to display a conversation between the user and the electronic device. That is, the questioning text and the response information in this embodiment may be used as a group of conversations. In addition, the position of the question and answer area may be configured by the operational staff.

In the above manner, the first intention control for the user to select an intention is provided on the first interface, so that the response information that satisfies the user's intention requirement can be accurately generated, and the user can obtain desired information more flexibly and efficiently, thereby satisfying the user's diversified data requirements in data search and analysis scenarios.

In some embodiments, the above information display method may further include the following steps: when displaying the response information, displaying a second intention control on the first interface and displaying an intention corresponding to the response information in a display area corresponding to the second intention control; and in response to an intention switching operation based on the second intention control, displaying response information that corresponds to the questioning text and satisfies a second target intention corresponding to the intention switching operation on the first interface, and displaying the second target intention in the display area corresponding to the second intention control.

The second intention control is used to generate a response text for another intention of the questioning text currently entered by the user. It should be noted that when the user does not trigger the intention switching operation, the display area corresponding to the second intention control displays the intention corresponding to the response information.

For example, the second intention control may be displayed below the response information.

For example, the questioning text entered by the user for the question input control is “Data of selling commodity XX in November”, and the first target intention selected on the basis of the first intention control is “Search for data”. After the generation operation is triggered, the first interface displays the response information that corresponds to the questioning text and satisfies the first target intention, which satisfies the user's requirement for searching for data. It can be understood that in this scenario, the user may still have a question about how to use the found data or a question about the definition of an indicator in the found data. In this case, the user can switch the intention to the business consultation based on the second intention control. Thus, the first interface of the electronic device displays an explanation of documents and indicators related to “Data of selling commodity XX in November”, thereby satisfying the user's other requirements for the found data.

FIG. 3 is another schematic diagram of the first interface according to an exemplary embodiment of the present disclosure. With reference to FIG. 3, the first interface displays the questioning text “Data of selling commodity XX in November” and the response information that satisfies the first target intention “Search for data”. Meanwhile, the first interface displays the second intention control, and the user can click on the second intention control to trigger the first interface to display the plurality of candidate intentions. The user can click on one of the plurality of the candidate intentions to trigger the intention switching operation, and then the electronic device displays, on the first interface, the response information that corresponds to the questioning text and satisfies the second target intention corresponding to the intention switching operation.

In the above manner, based on the first intention control and the second intention control, the display of the response texts for different intentions under the same questioning text can be quickly implemented, thereby satisfying the user's diversified data requirements in data search and analysis scenarios.

In some embodiments, the above information display method may further include the following step: switching the first target intention displayed in the display area corresponding to the first intention control to the second target intention in response to the intention switching operation based on the second intention control.

Thus, it is convenient for the user to ask follow-up questions for the same intention based on the question input control.

In some embodiments, the step of displaying, in response to a selection operation on a plurality of candidate intentions provided by the first intention control, a first target intention corresponding to the selection operation in a display area corresponding to the first intention control, may be implemented in the following manner: displaying a multilevel menu on the first interface in response to a click operation on the first intention control, in which sub-controls corresponding to the candidate intentions are displayed in each level menu of the multilevel menu, and in any two adjacent upper level menu and lower level menu, candidate intentions in the lower level menu are lower-level candidate intentions corresponding to candidate intentions in the upper level menu; and in response to a selection operation on the sub-controls corresponding to the plurality of candidate intentions displayed in the multilevel menu, displaying a first target intention corresponding to a sub-control in the display area corresponding to the first intention control.

For example, the candidate intention of searching for data, may has lower-level candidate intentions. For example, divided by a range covered by the data volume and a data use scenario, the lower-level intentions of searching for data may include a Hive table, a dashboard, a dataset, and the like. From the perspective of the data use scenario covered by the data volume, the dashboard may be used to visually display the data, that is, for different data use scenarios, the user may have a requirement for browsing graphical data or a requirement for browsing tabular data. From the perspective of the range covered by the data volume, the dataset may be an aggregation of a plurality of Hive tables in a certain business scenario.

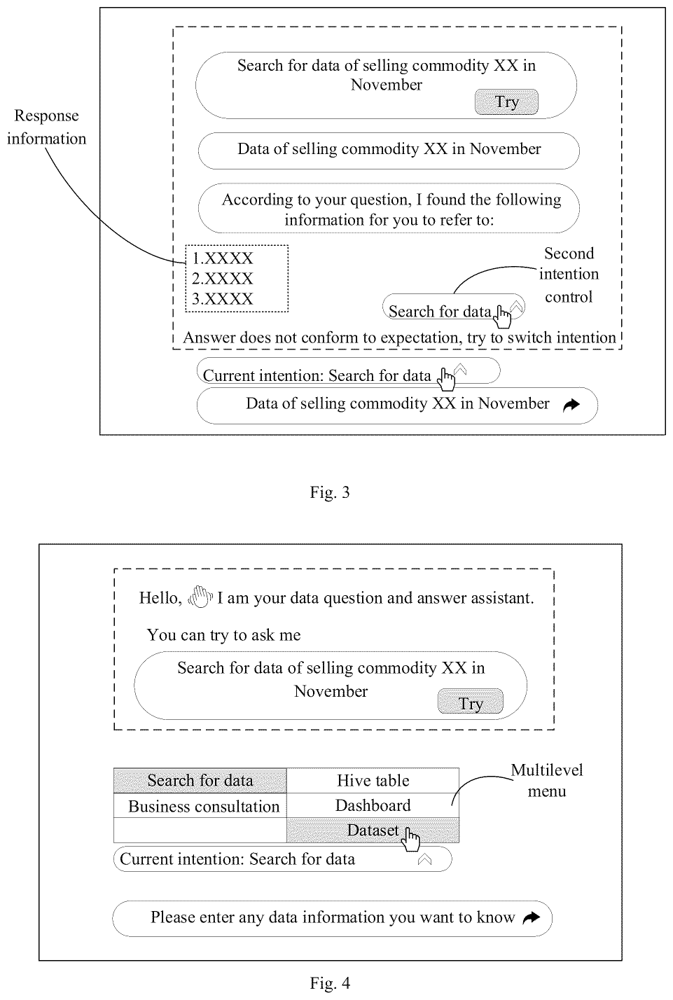

FIG. 4 is another schematic diagram of the first interface according to an exemplary embodiment of the present disclosure. As shown in FIG. 4, a visualized multilevel menu is used for the user to select from the plurality of candidate intentions. The user can click on the first intention control to trigger the click operation on the first intention control, and the first interface displays the highest-level menu in the multilevel menu. The highest-level menu includes the highest-level candidate intention, for example, “Search for data” and “Business consultation” shown in FIG. 4. In any two adjacent upper level menu and lower level menu, in response to a selection operation on a sub-control corresponding to a candidate intention in the higher-level menu, a menu corresponding to the candidate intention of the sub-control is added to the multilevel menu on the first interface, and the menu includes next-level candidate intentions corresponding to the candidate intention of the sub-control, for example, the next-level candidate intentions “Hive table”, “Dashboard”, and “Dataset” corresponding to “Search for data” displayed in FIG. 4. Further, in response to the selection operation on the sub-controls corresponding to the plurality of candidate intentions displayed in the multilevel menu, for example, the selection operation of selecting the “Dataset” shown in FIG. 4, the “Dataset” is used as the first target intention. As an example, the selection operation may be a double-click operation.

In the above manner, the display of different level candidate intentions is supported, and the readability of the candidate intentions is improved, which is conducive to the user quickly selecting the first target intention.

It should be noted that when implementing the intention switching operation based on the second intention control, the click operation on the second intention control may be preferentially responded to, and then the corresponding multilevel menu is displayed. Further, the selection operation on the sub-controls corresponding to the plurality of candidate intentions displayed in the multilevel menu is responded to, so as to implement the intention switching operation for triggering the second intention control. For the multilevel menu and the selection operation in this embodiment, reference may be made to the related embodiments mentioned above, and details are not described in this embodiment.

In some embodiments, the first interface further includes a third intention control, and the above information display method may further include the following steps: acquiring voice information in response to a voice input operation on the third intention control; recognizing the voice information by using a trained first intention recognition model to obtain a third target intention; and in response to the generation operation, displaying response information that corresponds to the questioning text and satisfies the third target intention on the first interface.

It should be noted that the third intention control is a control that supports the user to perform a voice input function. For example, the user can select an intention through the voice input operation on the third intention control, and the voice information may be, for example, “I want to view a dataset” or “I want to view a dashboard”.

The first intention recognition model is a voice recognition model. As an example, the voice recognition model may be a hidden Markov model (HMM). For the voice recognition model, reference may be made to the related art, and details are not described in this embodiment.

In the above manner, the user's manual operation can be reduced, and the efficiency of the user selecting an intention can be improved.

In a possible manner, the second intention control may also be a control that supports the user to perform a voice input function. Specifically, the step of in response to an intention switching operation based on the second intention control, displaying response information that corresponds to the questioning text and satisfies a second target intention corresponding to the intention switching operation on the first interface, may be implemented in the following manner: acquiring corresponding voice information in response to a voice input operation on the second intention control; and recognizing the voice information by using a trained first intention recognition model to obtain the second target intention, and displaying the response information that corresponds to the questioning text and satisfies the second target intention corresponding to the voice input operation on the first interface.

In some embodiments, the information display method may further include the following steps: recognizing the questioning text by using a trained second intention recognition model to obtain a fourth target intention, and displaying a confirmation control for the fourth target intention on the first interface; and in response to a confirmation operation on the confirmation control and in response to the generation operation, displaying response information that corresponds to the questioning text and satisfies the fourth target intention on the first interface.

The questioning text may be preprocessed, and the questioning text after being preprocessed is recognized by using the trained second intention recognition model. As an example, the preprocessing may include text cleaning, word segmentation, and stop word removal.

Keywords in the questioning text after being preprocessed may be first extracted, and the keywords are recognized by using the trained second intention recognition model to obtain the fourth target intention. The second intention recognition model is a language model based on BERT (Bidirectional Encoder Representations from Transformers). For the language model based on BERT, reference may be made to the related art, and details are not described in this embodiment.

For example, after the input operation on the question input control is performed, when the selection operation on the plurality of candidate intentions provided by the first intention control is not triggered within a preset duration, the questioning text may be recognized by using the trained second intention recognition model to obtain the fourth target intention, and the confirmation control for the fourth target intention is displayed on the first interface.

For example, the confirmation control may be displayed on the first interface in a pop-up window.

The user can click on the confirmation operation in the confirmation control to determine that the intention corresponding to the response information is the intention recommended by the second intention recognition model.

It should be noted that the user may not want to manually perform the selection operation on the plurality of candidate intentions provided by the first intention control. Therefore, the second intention recognition model may be used to recognize the questioning text to obtain the fourth target intention. Moreover, to enable users to choose their intentions autonomously, the confirmation control is provided to obtain the permission authorized by the user for using the intention recommended by the second intention recognition model to reply. Obviously, the above manner can not only simplify the user's operation, but also satisfy the user's diversified data requirements in data search and analysis scenarios.

In some embodiments, the information display method may further include the following steps: displaying a feedback control after displaying response information that corresponds to the questioning text and satisfies a fifth target intention on the first interface, in which the fifth target intention is the third target intention or the fourth target intention; generating an optimization sample in response to feedback information input based on the feedback control; and updating a target intention model based on the optimization sample, in which the target intention model is the first intention recognition model or the second intention recognition model.

For example, the feedback control may be displayed below the response information.

For example, the feedback control may be included in a component, and the component may include a prompt word, and the prompt word is used for prompting the user to make a corresponding feedback on whether the response information conforms to the expectation based on the feedback control. The feedback control may include a positive feedback control and a negative feedback control. Correspondingly, the component may further include expressions corresponding to the feedback component to enhance the interactivity and improve the interactive experience. For example, the feedback control corresponding to the positive feedback may use a smiling face expression to enhance the interactivity, and the feedback control corresponding to the negative feedback may use a crying face expression to enhance the interactivity.

For example, the user can click on the corresponding feedback control to input the feedback information. For example, the user can click on the positive feedback control to input a positive sample, and the current response text, the questioning text and the intention corresponding to the current response text may be used as a positive sample for optimizing the target intention model. The user can click on the negative feedback control to input a negative sample, and the current response text, the questioning text and the intention corresponding to the response text may be used as a negative sample for optimizing the target intention model.

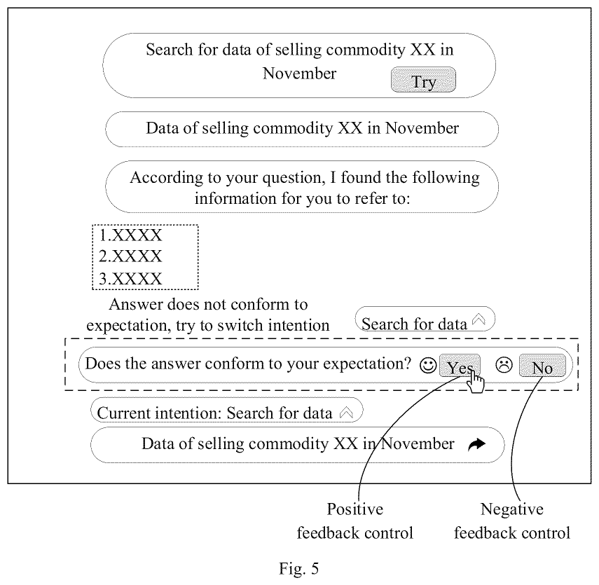

FIG. 5 is another schematic diagram of the first interface according to an exemplary embodiment of the present disclosure. With reference to FIG. 5, the prompt word may be “Does this answer conform to your expectation?”, the positive feedback control is, for example, the “Yes” control shown in FIG. 5, and the negative feedback control is, for example, the “No” control shown in FIG. 5.

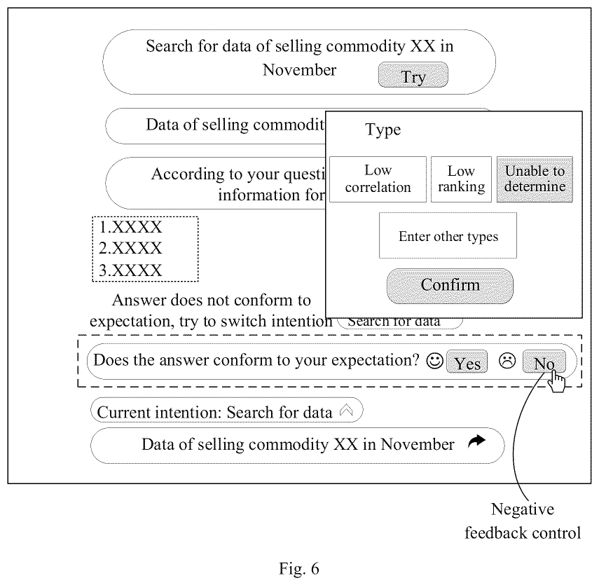

Further, for the negative feedback control, the user can be further provided with options to select a reason why the answer does not conform to the expectation, which enhances the capability of the information that can be provided by the feedback information. FIG. 6 is another schematic diagram of the first interface according to an exemplary embodiment of the present disclosure. With reference to FIG. 6, after the negative feedback control is clicked, a selection of types is displayed. The types include “Low correlation”, “Low ranking”, “Unable to determine” and other types that the user are supported to enter. The types are specific reasons that the response information does not conform to the expectation of the user.

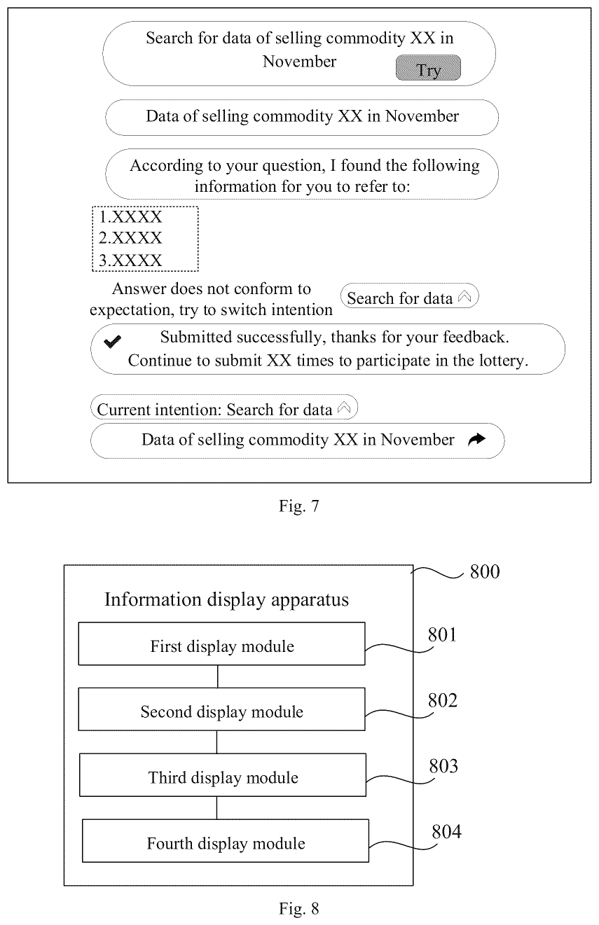

Further, after the user submits the feedback information, the first interface may display a prompt word, and the prompt word is used for encouraging the user to actively participate in the submission of the feedback information. FIG. 7 is another schematic diagram of the first interface according to an exemplary embodiment of the present disclosure. With reference to FIG. 7, the prompt word used for encouraging the user to actively participate in the submission of the feedback information may be “Submitted successfully, thanks for your feedback. Continue to submit XX times to participate in the lottery” as shown in FIG. 7.

It should be noted that there is an accuracy requirement for recognizing the corresponding intention by using the model. Therefore, a feedback mechanism may be used to collect the feedback information from the user, so that the model can be continuously optimized according to the user's evaluation to improve the accuracy of intention recognition, thereby improving the user experience.

Based on the same concept, an embodiment of the present disclosure provides an information display apparatus. FIG. 8 is a block diagram of an information display apparatus according to an exemplary embodiment of the present disclosure. With reference to FIG. 8, the information display apparatus 800 may include a first display module 801, a second display module 802, a third display module 803 and a fourth display module 804.

The first display module 801 is configured to display a first interface, in which the first interface includes a question input control and a first intention control.

The second display module 802 is configured to display a questioning text on the first interface in response to an input operation on the question input control.

The third display module 803 is configured to, in response to a selection operation on a plurality of candidate intentions provided by the first intention control, display a first target intention corresponding to the selection operation in a display area corresponding to the first intention control.

The fourth display module 804 is configured to display response information that corresponds to the questioning text and satisfies the first target intention on the first interface in response to a generation operation.

Optionally, the information display apparatus 800 further includes a fifth display module and a sixth display module.

The fifth display module is configured to display a second intention control on the first interface when the response information is displayed, and display an intention corresponding to the response information in a display area corresponding to the second intention control.

The sixth display module is configured to, in response to an intention switching operation based on the second intention control, display response information that corresponds to the questioning text and satisfies a second target intention corresponding to the intention switching operation on the first interface, and display the second target intention in the display area corresponding to the second intention control.

Optionally, the information display apparatus 800 further includes a first response module, which is configured to switch the first target intention displayed in the display area corresponding to the first intention control to the second target intention in response to the intention switching operation based on the second intention control.

Optionally, the third display module 803 is specifically configured to: display a multilevel menu on the first interface in response to a click operation on the first intention control, in which sub-controls corresponding to the candidate intentions are displayed in each level menu of the multilevel menu, and in any two adjacent upper level menu and lower level menu, candidate intentions in the lower level menu are lower-level candidate intentions corresponding to candidate intentions in the upper level menu; and in response to a selection operation on the sub-controls corresponding to the plurality of candidate intentions displayed in the multilevel menu, display a first target intention corresponding to a sub-control in the display area corresponding to the first intention control.

Optionally, the first interface further includes a third intention control, and the information display apparatus 800 further includes a first acquiring module, a first recognition module and a seventh display module.

The first acquiring module is configured to acquire voice information in response to a voice input operation on the third intention control.

The first recognition module is configured to recognize the voice information by using a trained first intention recognition model to obtain a third target intention.

The seventh display module is configured to, in response to the generation operation, display response information that corresponds to the questioning text and satisfies the third target intention on the first interface.

Optionally, the information display apparatus 800 further includes a second recognition module and an eighth display module.

The second recognition module is configured to recognize the questioning text by using a trained second intention recognition model to obtain a fourth target intention, and display a confirmation control for the fourth target intention on the first interface.

The eighth display module is configured to, in response to a confirmation operation on the confirmation control and in response to the generation operation, display response information that corresponds to the questioning text and satisfies the fourth target intention on the first interface.

Optionally, the information display apparatus 800 further includes a ninth display module, a generating module and an updating module.

The ninth display module is configured to a feedback control after displaying response information that corresponds to the questioning text and satisfies a fifth target intention on the first interface, in which the fifth target intention is the third target intention or the fourth target intention.

The generating module is configured to generate an optimization sample in response to feedback information input based on the feedback control; and

The updating module is configured to update a target intention model based on the optimization sample, in which the target intention model is the first intention recognition model or the second intention recognition model.

The implementation of each module in the information display apparatus 800 may refer to the above related embodiments, which are not described in the present disclosure.

Based on the same concept, an embodiment of the present disclosure provides a computer-readable medium, which stores a computer program. When the program is executed by a processor, the processor implements the steps of the above information display method.

Based on the same concept, an embodiment of the present disclosure provides an electronic device, which includes a memory and a processor. The memory is configured to store a computer program; and the processor is configured to execute the computer program in the memory to implement the steps of the above information display method.

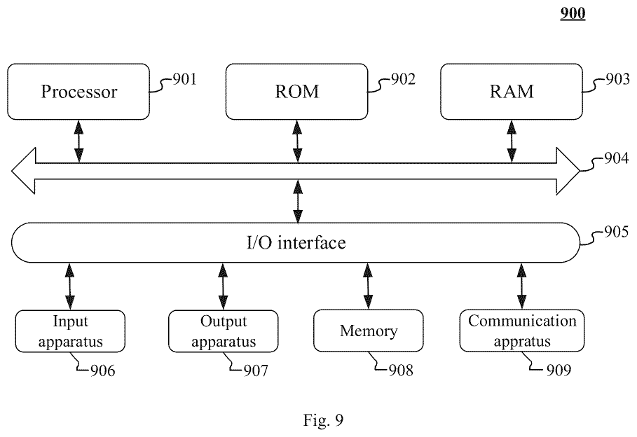

The following describes an electronic device 900 suitable for implementing embodiments of the present disclosure with reference to FIG. 9. The terminal device in this embodiment of the present disclosure may include, but is not limited to, mobile terminals such as a mobile phone, a notebook computer, a digital broadcast receiver, a personal digital assistant (PDA), a tablet computer (PAD), a portable multimedia player (PMP), and a vehicle-mounted terminal (such as a vehicle navigation terminal), and fixed terminals such as a digital TV and a desktop computer. The electronic device shown in FIG. 9 is merely an example, and shall not impose any limitation on the function and scope of use of the embodiments of the present disclosure.

As shown in FIG. 9, the electronic device 900 may include a processor (e.g., a central processor, a graphics processor, etc.) 901 that may perform a variety of appropriate actions and processing in accordance with a program stored in a read-only memory (ROM) 902 or a program loaded from a memory 908 into a random access memory (RAM) 903. The RAM 903 further stores various programs and data required for the operation of the electronic device 900. The processor 901, the ROM 902, and the RAM 903 are connected to each other through a bus 904. An input/output (I/O) interface 905 is also connected to the bus 904.

Generally, the following apparatuses may be connected to the I/O interface 905: an input apparatus 906 including, for example, a touch screen, a touchpad, a keyboard, a mouse, a camera, a microphone, an accelerometer, and a gyroscope; an output apparatus 907 including, for example, a liquid crystal display (LCD), a speaker, and a vibrator; the memory 908 including, for example, a tape and a hard disk; and a communication apparatus 909. The communication apparatus 909 may allow the electronic device 900 to perform wireless or wired communication with other devices to exchange data. Although FIG. 9 shows the electronic device 900 having various apparatuses, it should be understood that it is not required to implement or have all of the shown apparatuses. It may be an alternative to implement or have more or fewer apparatuses.

In particular, according to an embodiment of the present disclosure, the processes described above with reference to the flowcharts may be implemented as a computer software program. For example, this embodiment of the present disclosure includes a computer program product, which includes a computer program carried on a non-transitory computer-readable medium, where the computer program includes program code for performing the method shown in the flowchart. In such an embodiment, the computer program may be downloaded from a network through the communication apparatus 909 and installed, or installed from the memory 908, or installed from the ROM 902. When the computer program is executed by the processor 901, the above-mentioned functions defined in the method of the embodiment of the present disclosure are performed.

It should be noted that the above computer-readable medium described in the present disclosure may be a computer-readable signal medium, or a computer-readable storage medium, or any combination thereof. The computer-readable storage medium may be, for example but not limited to, electric, magnetic, optical, electromagnetic, infrared, or semiconductor systems, apparatuses, or devices, or any combination thereof. A more specific example of the computer-readable storage medium may include, but is not limited to: an electrical connection having one or more wires, a portable computer magnetic disk, a hard disk, a random access memory (RAM), a read-only memory (ROM), an erasable programmable read-only memory (EPROM or flash memory), an optic fiber, a portable compact disk read-only memory (CD-ROM), an optical storage device, a magnetic storage device, or any suitable combination thereof. In the present disclosure, the computer-readable storage medium may be any tangible medium including or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may also be any computer-readable medium other than the computer-readable storage medium. The computer-readable signal medium can send, propagate, or transmit a program used by or in combination with an instruction execution system, apparatus, or device. The program code included in the computer-readable medium may be transmitted by any suitable medium, including but not limited to: electric wires, optical cables, radio frequency (RF), etc., or any suitable combination thereof.

In some implementations, the electronic device may communicate using any currently known or future-developed network protocol such as a hypertext transfer protocol (HTTP), and may be connected to digital data communication (for example, a communication network) in any form or medium. Examples of the communication network include a local area network (“LAN”), a wide area network (“WAN”), an internetwork (for example, the Internet), a peer-to-peer network (for example, an ad hoc peer-to-peer network), and any currently known or future-developed network.

The above computer-readable medium may be included in the above electronic device. Alternatively, the computer-readable medium may exist independently, without being assembled into the electronic device.

The above computer-readable medium carries one or more programs that, when executed by the electronic device, cause the electronic device to: display a first interface, where the first interface includes a question input control and a first intention control; display a questioning text on the first interface in response to an input operation on the question input control; display, in a display area corresponding to the first intention control, a first target intention corresponding to a selection operation in response to the selection operation on a plurality of candidate intentions provided by the first intention control; and display, on the first interface in response to a generation operation, response information that corresponds to the questioning text and satisfies the first target intention.

The computer program code for performing operations in the present disclosure may be written in one or more programming languages or a combination thereof, where the programming languages include but are not limited to an object-oriented programming language, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the circumstance involving the remote computer, the remote computer may be connected to the computer of the user over any type of network, including a local area network (LAN) or a wide area network (WAN), or may be connected to an external computer (for example, connected over the Internet using an Internet service provider).

The flowcharts and the block diagrams in the accompanying drawings illustrate the possibly implemented architecture, functions, and operations of the system, the method, and the computer program product according to various embodiments of the present disclosure. In this regard, each block in the flowchart or block diagram may represent a module, program segment, or part of code, and the module, program segment, or part of code includes one or more executable instructions for implementing the specified logical functions. It should also be noted that, in some alternative implementations, the functions marked in the blocks may also occur in an order different from that marked in the accompanying drawings. For example, two blocks shown in succession may actually be performed substantially in parallel, or may sometimes be performed in the reverse order, depending on a function involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The modules described in the embodiments of the present disclosure may be implemented by means of software, or may be implemented by means of hardware. The name of the module does not constitute a limitation on the module in some cases.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system on chip (SOC), a complex programmable logic device (CPLD), and the like.

In the context of the present disclosure, a machine-readable medium may be a tangible medium that may include or store a program for use by or in combination with an instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor systems, apparatus, or devices, or any suitable combination thereof. A more specific example of the machine-readable storage medium may include an electrical connection based on one or more wires, a portable computer disk, a hard disk, a random access memory (RAM), a read-only memory (ROM), an erasable programmable read-only memory (EPROM or flash memory), an optic fiber, a portable compact disk read-only memory (CD-ROM), an optical storage device, a magnetic storage device, or any suitable combination thereof.

The above description is merely a preferred embodiment of the present disclosure and an illustration of the applied technical principles. Those skilled in the art should understand that the scope of disclosure involved in the present disclosure is not limited to the technical solution formed by the specific combination of the above technical features, and shall also cover other technical solutions formed by any combination of the above technical features or equivalent features thereof without departing from the above disclosure concept. For example, the technical solution formed by replacing the above features with technical features with similar functions disclosed in the present disclosure (but not limited thereto).

In addition, although the various operations are depicted in a specific order, it should be understood as requiring these operations to be performed in the specific order shown or in a sequential order. Under certain circumstances, multitasking and parallel processing may be advantageous. Similarly, although several specific implementation details are included in the foregoing discussions, these details should not be construed as limiting the scope of the present disclosure. Some features that are described in the context of separate embodiments can also be implemented in combination in a single embodiment. In contrast, various features described in a single embodiment may also be implemented in multiple embodiments individually or in any suitable sub-combination.

Although the subject matter has been described in a language specific to structural features and/or methodological logical actions, it should be understood that the subject matter defined in the appended claims is not necessarily limited to the specific features or actions described above. In contrast, the specific features and actions described above are merely exemplary forms of implementing the claims. With respect to the apparatus in the above embodiments, the specific manner in which each module performs an operation has been described in detail in the embodiments relating to the method, and will not be described in detail here.

1. An information display method, comprising:
displaying a first interface, wherein the first interface comprises a question input control and a first intention control;
displaying a questioning text on the first interface in response to an input operation on the question input control;
displaying, in response to a selection operation on a plurality of candidate intentions provided by the first intention control, a first target intention corresponding to the selection operation in a display area corresponding to the first intention control; and
displaying, in response to a generation operation, response information that corresponds to the questioning text and satisfies the first target intention on the first interface.

2. The method according to claim 1, further comprising:
when displaying the response information, displaying a second intention control on the first interface and displaying an intention corresponding to the response information in a display area corresponding to the second intention control; and
in response to an intention switching operation based on the second intention control, displaying response information that corresponds to the questioning text and satisfies a second target intention corresponding to the intention switching operation on the first interface, and displaying the second target intention in the display area corresponding to the second intention control.

3. The method according to claim 2, further comprising:
switching the first target intention displayed in the display area corresponding to the first intention control to the second target intention in response to the intention switching operation based on the second intention control.

4. The method according to claim 1, wherein the displaying, in response to a selection operation on a plurality of candidate intentions provided by the first intention control, a first target intention corresponding to the selection operation in a display area corresponding to the first intention control, comprises:
displaying a multilevel menu on the first interface in response to a click operation on the first intention control, wherein sub-controls corresponding to the candidate intentions are displayed in each level menu of the multilevel menu, and in any two adjacent upper level menu and lower level menu, candidate intentions in the lower level menu are lower-level candidate intentions corresponding to candidate intentions in the upper level menu; and
in response to a selection operation on the sub-controls corresponding to the plurality of candidate intentions displayed in the multilevel menu, displaying a first target intention corresponding to a sub-control in the display area corresponding to the first intention control.

5. The method according to claim 1, wherein the first interface further comprises a third intention control, and the method further comprises:
acquiring voice information in response to a voice input operation on the third intention control;
recognizing the voice information by using a trained first intention recognition model to obtain a third target intention; and
in response to the generation operation, displaying response information that corresponds to the questioning text and satisfies the third target intention on the first interface.

6. The method according to claim 1, further comprising:
recognizing the questioning text by using a trained second intention recognition model to obtain a fourth target intention, and displaying a confirmation control for the fourth target intention on the first interface; and
in response to a confirmation operation on the confirmation control and in response to the generation operation, displaying response information that corresponds to the questioning text and satisfies the fourth target intention on the first interface.

7. The method according to claim 5, further comprising:
displaying a feedback control after displaying response information that corresponds to the questioning text and satisfies a fifth target intention on the first interface, wherein the fifth target intention is the third target intention;
generating an optimization sample in response to feedback information input based on the feedback control; and
updating a target intention model based on the optimization sample, wherein the target intention model is the first intention recognition model.

8. The method according to claim 6, further comprising:
displaying a feedback control after displaying response information that corresponds to the questioning text and satisfies a fifth target intention on the first interface, wherein the fifth target intention is the fourth target intention;
generating an optimization sample in response to feedback information input based on the feedback control; and
updating a target intention model based on the optimization sample, wherein the target intention model is the second intention recognition model.

9. A non-transitory computer-readable medium, wherein a computer program is stored on the non-transitory computer-readable medium, when the computer program is executed by a processor, the processor implements an information display method, and the method comprises:
displaying a first interface, wherein the first interface comprises a question input control and a first intention control;
displaying a questioning text on the first interface in response to an input operation on the question input control;
displaying, in response to a selection operation on a plurality of candidate intentions provided by the first intention control, a first target intention corresponding to the selection operation in a display area corresponding to the first intention control; and
displaying, in response to a generation operation, response information that corresponds to the questioning text and satisfies the first target intention on the first interface.

10. The non-transitory computer-readable medium according to claim 9, wherein the method further comprises:
when displaying the response information, displaying a second intention control on the first interface and displaying an intention corresponding to the response information in a display area corresponding to the second intention control; and
in response to an intention switching operation based on the second intention control, displaying response information that corresponds to the questioning text and satisfies a second target intention corresponding to the intention switching operation on the first interface, and displaying the second target intention in the display area corresponding to the second intention control.

11. The non-transitory computer-readable medium according to claim 10, wherein the method further comprises:
switching the first target intention displayed in the display area corresponding to the first intention control to the second target intention in response to the intention switching operation based on the second intention control.

12. The non-transitory computer-readable medium according to claim 9, wherein the displaying, in response to a selection operation on a plurality of candidate intentions provided by the first intention control, a first target intention corresponding to the selection operation in a display area corresponding to the first intention control, comprises:
displaying a multilevel menu on the first interface in response to a click operation on the first intention control, wherein sub-controls corresponding to the candidate intentions are displayed in each level menu of the multilevel menu, and in any two adjacent upper level menu and lower level menu, candidate intentions in the lower level menu are lower-level candidate intentions corresponding to candidate intentions in the upper level menu; and
in response to a selection operation on the sub-controls corresponding to the plurality of candidate intentions displayed in the multilevel menu, displaying a first target intention corresponding to a sub-control in the display area corresponding to the first intention control.

13. The non-transitory computer-readable medium according to claim 9, wherein the first interface further comprises a third intention control, and the method further comprises:
acquiring voice information in response to a voice input operation on the third intention control;
recognizing the voice information by using a trained first intention recognition model to obtain a third target intention; and
in response to the generation operation, displaying response information that corresponds to the questioning text and satisfies the third target intention on the first interface.

14. The non-transitory computer-readable medium according to claim 9, wherein the method further comprises:
recognizing the questioning text by using a trained second intention recognition model to obtain a fourth target intention, and displaying a confirmation control for the fourth target intention on the first interface; and
in response to a confirmation operation on the confirmation control and in response to the generation operation, displaying response information that corresponds to the questioning text and satisfies the fourth target intention on the first interface.

15. An electronic device, comprising:
at least one memory, configured to store a computer program; and
at least one processor, configured to execute the computer program in the at least one memory to implement an information display method,
wherein the method comprises:
displaying a first interface, wherein the first interface comprises a question input control and a first intention control;
displaying a questioning text on the first interface in response to an input operation on the question input control;
displaying, in response to a selection operation on a plurality of candidate intentions provided by the first intention control, a first target intention corresponding to the selection operation in a display area corresponding to the first intention control; and
displaying, in response to a generation operation, response information that corresponds to the questioning text and satisfies the first target intention on the first interface.

16. The electronic device according to claim 15, wherein the method further comprises:
when displaying the response information, displaying a second intention control on the first interface and displaying an intention corresponding to the response information in a display area corresponding to the second intention control; and
in response to an intention switching operation based on the second intention control, displaying response information that corresponds to the questioning text and satisfies a second target intention corresponding to the intention switching operation on the first interface, and displaying the second target intention in the display area corresponding to the second intention control.

17. The electronic device according to claim 16, wherein the method further comprises:
switching the first target intention displayed in the display area corresponding to the first intention control to the second target intention in response to the intention switching operation based on the second intention control.

18. The electronic device according to claim 15, wherein the displaying, in response to a selection operation on a plurality of candidate intentions provided by the first intention control, a first target intention corresponding to the selection operation in a display area corresponding to the first intention control, comprises:
displaying a multilevel menu on the first interface in response to a click operation on the first intention control, wherein sub-controls corresponding to the candidate intentions are displayed in each level menu of the multilevel menu, and in any two adjacent upper level menu and lower level menu, candidate intentions in the lower level menu are lower-level candidate intentions corresponding to candidate intentions in the upper level menu; and
in response to a selection operation on the sub-controls corresponding to the plurality of candidate intentions displayed in the multilevel menu, displaying a first target intention corresponding to a sub-control in the display area corresponding to the first intention control.

19. The electronic device according to claim 15, wherein the first interface further comprises a third intention control, and the method further comprises:
acquiring voice information in response to a voice input operation on the third intention control;
recognizing the voice information by using a trained first intention recognition model to obtain a third target intention; and
in response to the generation operation, displaying response information that corresponds to the questioning text and satisfies the third target intention on the first interface.

20. The electronic device according to claim 15, wherein the method further comprises:
recognizing the questioning text by using a trained second intention recognition model to obtain a fourth target intention, and displaying a confirmation control for the fourth target intention on the first interface; and
in response to a confirmation operation on the confirmation control and in response to the generation operation, displaying response information that corresponds to the questioning text and satisfies the fourth target intention on the first interface.
